(19) United States
(12) Patent Application Publication
(10) Pub. No.: US 2010/0305885 A1
(43) Pub. Date: Dec. 2, 2010

(54) SYSTEM AND METHOD FOR DETECTING ADULTERATION OF FUEL OR OTHER MATERIAL USING WIRELESS MEASUREMENTS

(75) Inventors: Viswanath Ganapathy, Bangalore (IN); Vijendran G. Venkoparao, Bangalore (IN); Bin Sai, Den Haag (NL); Vijayakumar Basalingappa, Gulbarga (IN); Lokesh Sambasivan, Bangalore (IN)

Correspondence Address: HONEYWELL/MUNCK;Patent Services, 101 Columbia Road, P.O. Box 2245, Morristown, NJ, 07962-2245, US

(73) Assignee: Enraf B. V., Delft (NL)

(21) Appl. No.: 12/473,156

(22) Filed: May 27, 2009

(51) Int. Cl. G01F 23/284; G01N 9/04

(52) U.S. Cl. 702/55; 73/290 V; 73/32 R

(57) ABSTRACT

A method includes transmitting wireless signals toward material in a tank. The method also includes receiving first return wireless signals reflected off a surface of the material and identifying a level of the material in the tank using the first return wireless signals. The method further includes receiving second return wireless signals reflected off a bottom of the tank and determining whether the material has been adulterated using the level of the material in the tank and the second return wireless signals. Determining whether the material has been adulterated could include determining a dielectric constant of the material, determining a density of the material using the dielectric constant of the material, and comparing the determined density of the material against a specified density. Determining the dielectric constant of the material could include using a time between peaks associated with the first and second return wireless signals.

### TECHNICAL FIELD

This disclosure relates generally to material analysis systems and more specifically to a system and method for detecting adulteration of fuel or other material using wireless measurements.

### BACKGROUND

The detection of adulteration of fuel or other material is often an important function in various industries. Adulteration typically occurs when undesirable material is added to desired material. For example, adulteration may occur when kerosene is mixed with gasoline or diesel fuel. This is often done because kerosene is easily accessible and cheaper than gasoline or diesel fuel. However, the use of adulterated fuel typically causes greater pollution, decreases the performance of engines or other machines, and causes damage to the engines or other machines. It also typically results in monetary losses for purchasers of the adulterated fuel.

Conventional techniques for detecting fuel adulteration are often offline techniques, meaning those techniques involve testing in laboratories away from areas where the fuel is stored or transferred. The conventional techniques are also not typically real-time techniques, meaning the analysis often occurs after the fuel has been transferred from one party to another. In addition, these techniques require physical contact with the fuel in order to obtain samples for analysis.

### SUMMARY

This disclosure provides a system and method for detecting adulteration of fuel or other material using wireless measurements.

In a first embodiment, a method includes transmitting wireless signals toward material in a tank. The method also includes receiving first return wireless signals reflected off a surface of the material and identifying a level of the material in the tank using the first return wireless signals. The method further includes receiving second return wireless signals reflected off a bottom of the tank and determining whether the material has been adulterated using the level of the material in the tank and the second return wireless signals.

In a second embodiment, a system includes a transmitter configured to transmit wireless signals toward material in a tank and a receiver configured to receive the wireless signals. The system also includes an analyzer configured to determine whether the material has been adulterated using the received wireless signals.

In a third embodiment, a computer readable medium embodies a computer program. The computer program includes computer readable program code for identifying a level of material in a tank using first return wireless signals reflected off a surface of the material. The computer program also includes computer readable program code for determining whether the material has been adulterated using the level of the material in the tank and second return wireless signals reflected off a bottom of the tank.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system for detecting adulteration of material according to this disclosure;

FIGS. 2 and 3 illustrate example waveforms representing signals used to detect adulteration of material according to this disclosure;

FIG. 4 illustrates an example link budget analysis for use in detecting adulteration of material according to this disclosure; and

FIG. 5 illustrates an example method for detecting adulteration of material according to this disclosure.

### DETAILED DESCRIPTION

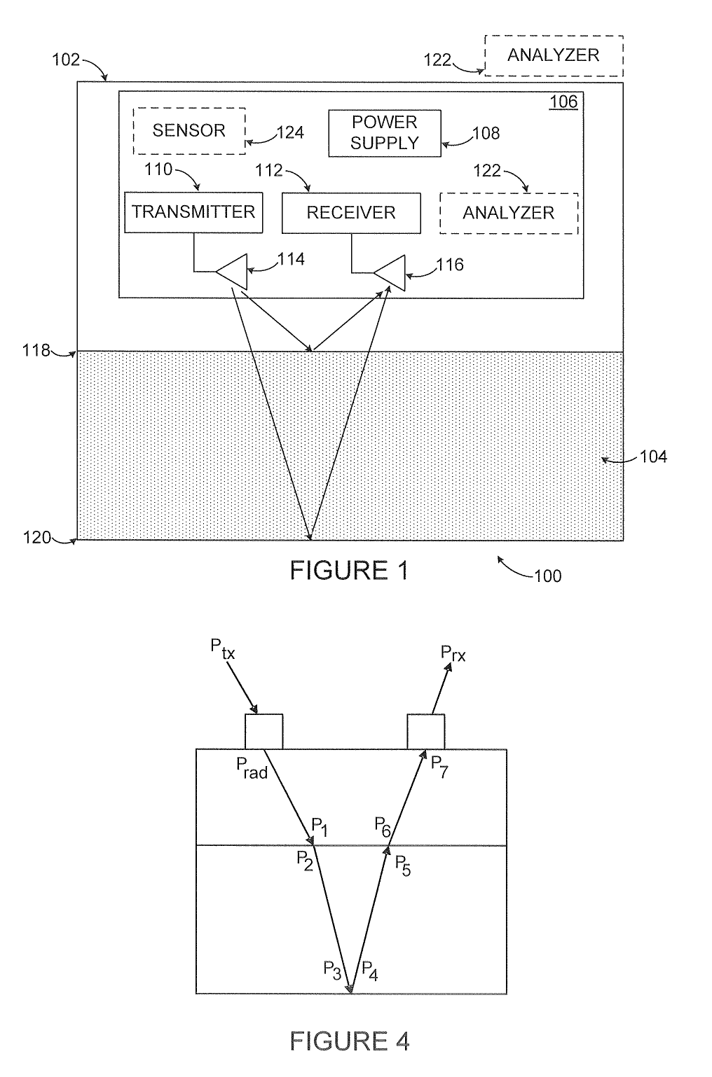

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for detecting adulteration of material according to this disclosure. In this example embodiment, the system 100 includes a tank 102. The tank 102 generally represents any suitable structure for receiving and storing at least one liquid or other material 104. Also, the tank 102 could have any suitable shape and size. Further, the tank 102 could form part of a larger structure. The larger structure could represent any fixed or movable structure containing or associated with one or more tanks 102, such as a movable tanker vessel, railcar, or truck or a fixed tank farm.

The tank 102 could be used to store any suitable material 104. As particular examples, the material 104 in the tank 102 could represent gasoline, diesel fuel, or some other form of fuel (which could have any of a number of octanes or other characteristics). As other particular examples, the material 104 could represent one or more vegetable oils or some other form(s) of hydrocarbon(s).

In this example embodiment, the system 100 includes an adulteration detector 106. As explained in more detail below, in some embodiments, the adulteration detector 106 uses wireless signals to estimate the dielectric constant and density of the material 104 in the tank 102, which can be used to detect adulteration of the material.

As shown in FIG. 1, the adulteration detector 106 includes a power supply 108, which supplies power to other components of the adulteration detector 106. The power supply 108 could represent any suitable source of operating power. The power supply 108 could, for example, represent a battery.

The adulteration detector 106 also includes a transmitter 110 and a receiver 112. The transmitter 110 and the receiver 112, along with their antennas 114-116, respectively transmit and receive wireless signals. In some embodiments, the transmitter 110 and the receiver 112 support the use of ultra wideband (UWB) Time Domain Reflectometry (TDR) by the adulteration detector 106. For example, the transmitter 110 and the antenna 114 transmit wireless signals toward the material 104 in the tank 102, such as by transmitting the signals in a generally downward direction in the tank 102. The antenna 116 and the receiver 112 receive the wireless signals that have reflected off one or more components. As shown in FIG. 1, the wireless signals received by the antenna 116 and the receiver 112 include signals reflecting off an air-material interface 118 and signals reflecting off a bottom 120 of the tank 102. The transmitter 110 includes any structure(s) for providing signals for wireless transmission. The receiver 112 includes any structure(s) for obtaining and processing signals received wirelessly. Although shown as separate elements, the transmitter 110 and the receiver 112 could represent a single transceiver. Each of the antennas 114-116 represents any structure(s) for transmitting and/or receiving wireless signals. Although shown as using two different antennas, the transmitter 110 and the receiver 112 could share one or more common antennas.

Any suitable wireless signals could be used by the adulteration detector 106. For example, the adulteration detector 106 could use UWB radio frequency (RF) signals or terahertz (THz) waves. In particular embodiments, the transmitter 110 and the antenna 114 could transmit UWB pulses or terahertz waves having extremely short durations (the duration of the pulses or waves can be determined as described below). However, any other suitable wireless signals could be used here.

The wireless signals received by the antenna 116 and the receiver 112 are processed by an analyzer 122. The analyzer 122 can determine the level of the material 104 in the tank 102 using the wireless signals reflected off the air-material interface 118. The analyzer 122 can then use the level of the material 104 along with other calculations to determine if adulteration of the material 104 is detected.

In some embodiments, the detection of adulteration could occur as follows. The analyzer 122 can estimate the length of the path traveled by wireless signals reflected off the bottom 120 of the tank 102 using the level of the material 104. The analyzer 122 can also determine the time of flight for the wireless signals reflected off the bottom 120 of the tank 102. The time of flight represents the length of time from transmission of the wireless signal to reception of the wireless signals. The length of the path and the time of flight can be used by the analyzer 122 to estimate the dielectric constant of the material 104 in the tank 102, which can be used to estimate the density of the material 104 in the tank 102.

By comparing the computed density of the material 104 to an expected or desired density, the analyzer 122 can determine whether the material 104 in the tank 102 has been adulterated. The analyzer 122 could also determine the level of adulteration, such as by examining the difference between the expected or desired density and the measured density of the material 104. The analyzer 122 could also output various data, such as an indication whether adulteration is detected or the level of adulteration. The output could be sent to any suitable destination(s), such as a mobile user device, an audible or visual alarm, or a display.

The analyzer 122 includes any suitable structure(s) for analyzing signals from a receiver to detect and/or measure adulteration of material. For example, the analyzer 122 could include digital acquisition (DAQ) hardware for capturing information about the received wireless signals in digital form. The analyzer 122 could also include processing hardware for processing the captured information, such as a microprocessor, microcontroller, or digital signal processor. As shown in FIG. 1, the analyzer 122 could form part of the adulteration detector 106 or reside outside the adulteration detector 106 (and possibly even outside the tank 102).

The adulteration detector 106 may further include one or more sensors 124, which can be used to measure one or more characteristics in the tank 102. For example, the dielectric constant of the material 104 could vary with temperature, and a sensor 124 could estimate or determine the temperature of the material 104. Any other or additional sensor(s) could be used.

The adulteration detector 106 can provide various benefits depending on the implementation. For example, the adulteration detector 106 can support the detection of adulterated fuel or other material “in the field” outside of a laboratory environment. The adulteration detector 106 could also operate in a real-time manner. Further, the adulteration detector 106 can operate in a non-contact manner, meaning the adulteration detector 106 need not physically contact the material 104 in the tank 102. Moreover, the adulteration detector 106 can provide accurate estimates of the level of material 104 in the tank 102, which can be used for other functions (such as verifying that the tank 102 contains a desired level of material or facilitating the filling of the tank 102). In addition, the adulteration detector 106 can be designed to detect even small variations in the dielectric constant of the material 104, such as a 4% variation or even less. Small variations in dielectric constant can be measured since, for example, UWB pulses can be of very short duration (such as less than ins, like a few tens of picoseconds or even less) or terahertz wave pulses can be of very short duration (such as several femtoseconds or other durations less than 1 ps). This may allow the adulteration detector 106 to detect adulation more accurately.

Note that while Time Domain Reflectometry is described as being used by the adulteration detector 106, other techniques could be supported by the adulteration detector 106. For example, the adulteration detector 106 could use bi-static RADAR-based measurements (used with a non-metallic tank 102) to detect adulteration.

Although FIG. 1 illustrates an example system 100 for detecting adulteration of material, various changes may be made to FIG. 1. For example, while shown as residing inside the tank 102, the adulteration detector 106 could represent a portable unit that can be attached to and removed from one or multiple tanks 102. Also, the functional division of the adulteration detector 106 is for illustration only. The components shown in FIG. 1 could be omitted, combined, or further subdivided and additional components could be added according to particular needs. For instance, the components shown in FIG. 1 could be incorporated into a gauge that is used to measure and display the level of material 104 in the tank 102. In addition, FIG. 1 illustrates one operational environment in which adulteration detection can be used. This functionality could be used in any other suitable system.

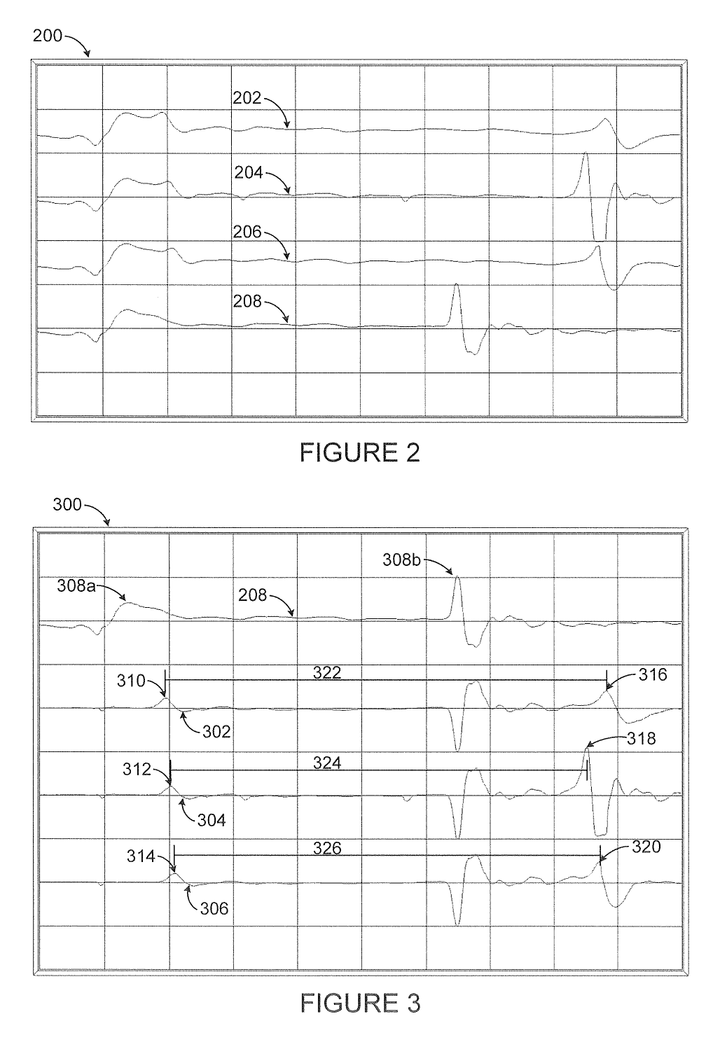

FIGS. 2 and 3 illustrate example waveforms representing signals used to detect adulteration of material according to this disclosure. In FIG. 2, a graph 200 includes various waveforms 202-208 representing wireless signals that could be received in different scenarios. In particular, the waveform 202 represents wireless signals that may travel through gasoline in the tank 102. The waveform 204 represents wireless signals that may travel through kerosene in the tank 102. The waveform 206 represents wireless signals that may travel through a mixture of 50% gasoline and 50% kerosene in the tank 102. The waveform 208 represents a background reading obtained without any material 104 in the tank 102.

The analyzer 122 can analyze these signals as follows. An example analysis is shown in FIG. 3, which shows a graph 300 that includes various waveforms 208 and 302-306. Here, the background reading is represented by the waveform 208. Various portions 308a-308b of the waveform 208 are associated with crosstalk created by the antennas of the adulteration detector 106. The analyzer 122 can generate a waveform 302-306 by subtracting the background reading from one of the waveforms 202-206. In other words, the waveform 302 represents the wireless signals reflected from gasoline after removal of the effects of antenna crosstalk and other background noise. Similarly, the waveform 304 represents the wireless signals passing through kerosene after removal of the effects of antenna crosstalk and other background noise. The waveform 306 represents the wireless signals passing through a mixture of 50% gasoline and 50% kerosene after removal of the effects of antenna crosstalk and other background noise.

The analyzer 122 can then analyze the waveform 302-306 to identify the dielectric constant of the material 104 in the tank 102. As shown in FIG. 3, the waveforms 302-306 include peaks 310-314, respectively. These peaks 310-314 represent the times when the largest amount of wireless signals are reflected off the air-material interface 118 in the tank 102. Also, the waveforms 302-306 include additional peaks 316-320, respectively. These peaks 316-320 represent the times when the largest amount of wireless signals are reflected off the bottom 120 of the tank 102. The analyzer 122 can use these various peaks to identify time intervals 322-326, respectively, which represent different delays associated with wireless signals that are propagating through the different materials. As can be seen here, different compositions of material 104 result in different delays.

Using the time interval for a specific material 104 being analyzed, the analyzer 122 can estimate the dielectric constant of that material 104. For example, the analyzer 122 could use the following formula to estimate the dielectric constant of the material 104:

$$ɛ = {( \frac{cD}{2 L} )}^{2} . \qquad ( 1 )$$

Here, ∈ represents the dielectric constant of the material 104, and c represents the speed of light (nominally 300 mm/ns). Also, D represents the delay (time interval) computed as described above using the peaks of the relevant waveform, and L represents the level of the material 104 in the tank 102. The level L can be determined, for example, using the wireless signals reflected off the air-material interface 118 and off the bottom 120 of the tank 102.

Once the dielectric constant of the material 104 being examined is determined, the analyzer 122 could then calculate the density of that material 104. The analyzer 122 could use any suitable technique to determine the density of a material using the material's dielectric constant. In some embodiments, the analyzer 122 could use the following formula to estimate the density of the material 104:

log(∈−1)=A+B log ρ. (2)

Here, ρ represents the density of the material 104, and A and B are constants (which can be defined using experimental data). One technique for determining the values of A and B for a homogeneous liquid and estimating the density of a material based on its dielectric constant is disclosed in Marshall, “Dielectric Constant of Liquids (Fluids) Shown to be Simple Fundamental Relation of Density over Extreme Ranges from −50° to +600° C., Believed Universal,” Nature Precedings, 5 Nov. 2008 (which is hereby incorporated by reference). Equation (2) expresses the dielectric constant ∈ as dielectric susceptibility (∈-1), which is isothermally proportional to the density ρ raised to a constant power given in logarithmic form.

The analyzer 122 can then compare the computed density of the material 104 to the expected or desired density (such as the density of an unadulterated fuel). If the measured density of the material 104 is different than the expected or desired density (such as by a threshold amount), the analyzer 122 could determine that adulteration has occurred and act accordingly, such as by triggering an alarm. Also, the analyzer 122 could analyze the difference between the measured density of the material 104 and the expected or desired density to determine the level of adulteration. Otherwise, the analyzer 122 could indicate that no adulteration has been detected.

Note that the analyzer 122 could perform other operations to detect adulteration. For example, the analyzer 122 need not compute the density of the material 104. In other embodiments, for instance, the analyzer 122 could estimate the composition of the material 104 using the calculated dielectric constant of the material 104. In still other embodiments, the analyzer 122 could estimate the composition of the material 104 using the amplitude of the received wireless signals or the delay 322-326 between peaks as shown in FIG. 3.

Although FIGS. 2 and 3 illustrate example waveforms representing signals used to detect adulteration of material, various changes may be made to FIGS. 2 and 3. For example, the waveforms shown in FIGS. 2 and 3 are for illustration only. These waveforms are associated with particular materials stored in a particular container (tank) that has particular dimensions and composition. Different waveforms may be associated with different materials in the same tank or with the same or different materials in different tanks.

FIG. 4 illustrates an example link budget analysis for use in detecting adulteration of material according to this disclosure. A link budget analysis can be performed to estimate the transmit power needed so that wireless signals are reflected off the bottom 120 of the tank 102 and arrive at the receiver 112 with a signal-to-noise ratio (SNR) above the sensitivity of the receiver 112.

In FIG. 4, the transmit power is denoted Pₜₓ, and the radiated power is denoted P_{rad}. The power received at the air-material interface 118 is denoted P₁, and the power coupled into the material 104 is denoted P₂. The power at the tank bottom 120 is denoted P₃, and the power reflected from the tank bottom 120 is denoted P₄. The power at the air-material interface 118 is denoted P₅, and the power transmitted out of the air-material interface 118 is denoted P₆. The power at the receiver antenna 116 is denoted P₇, and the power at the receiver 112 is denoted Pᵣₓ.

The link budget analysis can calculate the minimal transmit power Pₜₓ needed so that the received power Pᵣₓ is greater than the receiver's sensitivity. Some factors that contribute to signal loss are spreading losses, material attenuation losses, transmission coupling losses, retransmission coupling losses, and scattering losses.

Assume the material 104 represents gasoline with a complex dielectric constant of 2+0.003i. Also assume that the loss factor through gasoline is 0.003, the depth of the tank 102 is 10 m, and the height of the material 104 is 5 m. Let the center frequency of the transmitted wireless signals be 5 GHz and the bandwidth of the wireless signals be 2 GHz. The total loss through the medium can be obtained by accounting for antenna losses, attenuation losses, spreading losses, scattering losses (at the air-material interface 118), and transmission losses (at the interface 118). The sum of scattering losses and transmission losses for this tank dimension could be around −1.5 dB, with spreading losses of around −49 dB, attenuation losses of around −4.9 dB, and antenna coupling losses at the transmitter 110 and receiver 112 of around −2 dB. The total loss is therefore about −57 dB in this example. If the receiver sensitivity for the given signals is −66 dB, the minimum transmit power may be equal to the sensitivity of the receiver 112 minus the total path loss, or around −9 dB.

The link budget analysis can also be used to coarsely estimate other parameters of the wireless signals, such as pulse duration. A finite-difference time-domain (FDTD) analysis that can incorporate effects such as dispersion may also be used to obtain more accurate estimates of the pulse parameters. The actual duration of the pulses can be based on various factors. These factors can include the variation in dielectric constant to be detected (where smaller variations require shorter pulse durations). These factors can also include the field of view (FOV) of the transmit antenna 114 and the path loss of the wireless signals.

Although FIG. 4 illustrates an example link budget analysis for use in detecting adulteration of material, various changes may be made to FIG. 4. For example, any other suitable variables or techniques could be used to estimate the parameters of the wireless signals used to detect adulteration of material.

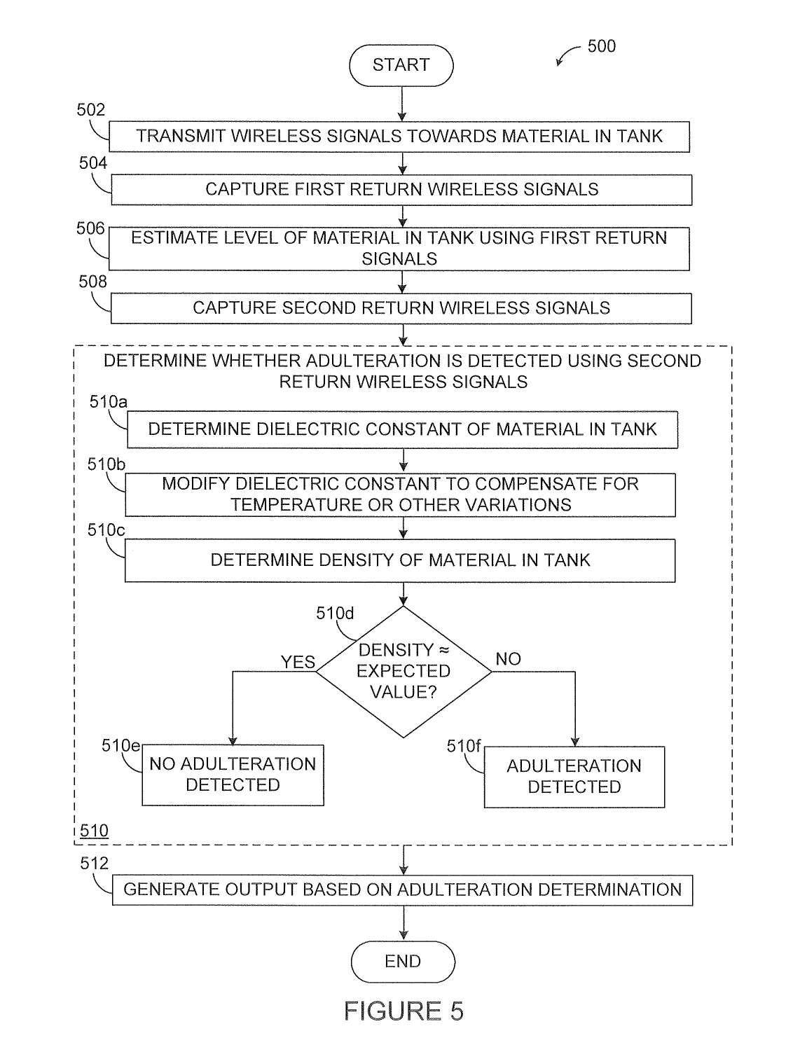

FIG. 5 illustrates an example method 500 for detecting adulteration of material according to this disclosure. As shown in FIG. 5, wireless signals are transmitted toward material in a tank at step 502. This could include, for example, the transmitter 110 and the antenna 114 generating UWB wireless signals or terahertz waves containing pulses having a desired pulse width/duration.

First return wireless signals are captured at step 504. This could include, for example, the antenna 116 and the receiver 112 capturing wireless signals reflected off the surface of the material 104 in the tank 102 (at the air-material interface 118). A level of the material in the tank is estimated using the first return wireless signals at step 506. This could include, for example, the analyzer 122 using the time of flight of the wireless signals to estimate the distance traveled by the wireless signals from the antenna 114 to the antenna 116. In some embodiments, determining the level of material 104 in the tank 102 may require that the actual height of the tank 102 or the relative position of the transmit and receive antennas 114-116 in the tank 102 be known.

Second return wireless signals are captured at step 508. This could include, for example, the antenna 116 and the receiver 112 capturing wireless signals reflected off the bottom 120 of the tank 102. A determination is made whether adulteration of the material in the tank is detected using the second return wireless signals at step 510. As noted above, this step could take several forms.

In FIG. 5, step 510 includes determining the dielectric constant of the material in the tank at sub-step 510a. This could include, for example, the analyzer 122 using Equation (1) above. The dielectric constant is modified if necessary to compensate for temperature or other variations at sub-step 510b. This could include, for example, the analyzer 122 using one or more calibration charts indicating how to adjust the dielectric constant given changes in temperature. This could also include the analyzer 122 compensating for pulse drift, phase drift, or other environmental or other problems. A density of the material in the tank is determined at sub-step 510c. This could include, for example, the analyzer 122 using Equation (2) above. A determination is made whether the calculated density is at or near an expected value at sub-step 510d. This could include, for example, the analyzer 122 determining whether the calculated density is within a threshold amount of an expected or desired density. If so, no adulteration may be detected at sub-step 510e. Otherwise, adulteration may be detected at sub-step 510f.

In any case, an output is generated based on the adulteration determination at step 512. This could include, for example, the analyzer 122 producing an indicator identifying whether adulteration is detected and, if adulteration is detected, the level of adulteration. This could also include the analyzer 122 triggering an audible or visual alarm if adulteration is detected. This could further include the analyzer 122 storing any relevant data or transmitting the data for operator review. The analyzer 122 could take any other or additional action(s) based on the adulteration determination according to particular needs.

Although FIG. 5 illustrates an example method 500 for detecting adulteration of material, various changes may be made to FIG. 5. For example, while shown as a series of steps, various steps in FIG. 5 could overlap, occur in parallel, or occur multiple times. Also, as noted above, step 510 could involve other techniques for detecting adulteration. For instance, the composition of the material 104 in the tank 102 could be estimated using the calculated dielectric constant of the material 104, the amplitude of the received wireless signals, the time of flight of the wireless signals, or the delay between peaks in the wireless signals.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The term “program” refers to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
transmitting wireless signals toward material in a tank;
receiving first return wireless signals reflected off a surface of the material;
identifying a level of the material in the tank using the first return wireless signals;
receiving second return wireless signals reflected off a bottom of the tank; and
determining whether the material has been adulterated using the level of the material in the tank and the second return wireless signals.

2. The method of claim 1, wherein determining whether the material has been adulterated comprises:
determining a dielectric constant of the material.

3. The method of claim 2, wherein determining the dielectric constant of the material comprises using a delay associated with receipt of the first and second return wireless signals.

4. The method of claim 3, further comprising determining the delay by:
identifying a first peak in received wireless signals, the first peak associated with the receipt of the first return wireless signals;
identifying a second peak in the received wireless signals, the second peak associated with the receipt of the second return wireless signals; and
identifying a time between the peaks.

5. The method of claim 2, wherein determining whether the material has been adulterated further comprises:
determining a density of the material in the tank using the dielectric constant of the material.

6. The method of claim 5, wherein determining whether the material has been adulterated further comprises:
comparing the determined density of the material against a specified density; and
determining whether the material has been adulterated based on the comparison.

7. The method of claim 1, further comprising:
if adulteration is detected, determining a level of the adulteration of the material.

8. The method of claim 1, wherein the wireless signals comprise ultra wideband (UWB) radio frequency (RF) signals, the UWB RF signals comprising pulses with a duration less than one nanosecond.

9. A system comprising:
a transmitter configured to transmit wireless signals toward material in a tank;
a receiver configured to receive the wireless signals; and
an analyzer configured to determine whether the material has been adulterated using the received wireless signals.

10. The system of claim 9, wherein the analyzer is configured to determine whether the material has been adulterated by:
identifying a level of the material in the tank using first return wireless signals reflected off a surface of the material; and
determining whether the material has been adulterated using the level of the material in the tank and second return wireless signals reflected off a bottom of the tank.

11. The system of claim 10, wherein the analyzer is configured to determine whether the material has been adulterated by:
determining a dielectric constant of the material using the level of the material in the tank and the second return wireless signals.

12. The system of claim 11, wherein the analyzer is configured to determine the dielectric constant of the material using a delay associated with receipt of the first and second return wireless signals.

13. The system of claim 12, wherein the analyzer is configured to determine the delay associated with the receipt of the first and second return wireless signals by:
identifying a first peak in the received wireless signals, the first peak associated with the receipt of the first return wireless signals;
identifying a second peak in the received wireless signals, the second peak associated with the receipt of the second return wireless signals; and
identifying a time between the peaks, the time between the peaks representing the delay.

14. The system of claim 11, wherein the analyzer is configured to determine whether the material has been adulterated by:
determining a density of the material in the tank using the dielectric constant of the material.

15. The system of claim 14, wherein the analyzer is configured to determine whether the material has been adulterated by:
comparing the determined density of the material against a specified density; and
determining whether the material has been adulterated based on the comparison.

16. The system of claim 9, wherein the analyzer is further configured to determine a level of the adulteration of the material.

17. The system of claim 9, wherein the transmitter, the receiver, and the analyzer reside within a single detector unit.

18. A computer readable medium embodying a computer program, the computer program comprising:
computer readable program code for identifying a level of material in a tank using first return wireless signals reflected off a surface of the material; and
computer readable program code for determining whether the material has been adulterated using the level of the material in the tank and second return wireless signals reflected off a bottom of the tank.

19. The computer readable medium of claim 18, wherein the computer readable program code for determining whether the material has been adulterated comprises:
computer readable program code for determining a dielectric constant of the material;
computer readable program code for determining a density of the material using the dielectric constant of the material; and
computer readable program code for comparing the determined density of the material against a specified density.

20. The computer readable medium of claim 19, wherein the computer readable program code for determining the dielectric constant of the material comprises:
computer readable program code for identifying a first peak in received wireless signals, the first peak associated with the receipt of the first return wireless signals;
computer readable program code for identifying a second peak in the received wireless signals, the second peak associated with the receipt of the second return wireless signals;
computer readable program code for identifying a time between the peaks; and
computer readable program code for determining the dielectric constant of the material using the identified time between the peaks.
